(19) United States
(12) Patent Application Publication
(10) Pub. No.: US 2006/0280177 A1
(43) Pub. Date: Dec. 14, 2006

(54) Integration network for digital media solutions

(76) Inventors: Pawan Kumar Gupta, Kamataka (IN); Sathyanarayanan Jambunathan, Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/151,561

(22) Filed: Jun. 13, 2005

(51) Int. Cl. H04J 3/22; H04J 3/16; H04L 12/56; H04L 12/28; H04L 12/66

(52) U.S. Cl. 370/389; 370/465

(57) ABSTRACT

A technique that provides an integration network for digital media solutions by seamlessly linking one or more digital media applications with one or more associated media services. In one example embodiment, this is achieved by linking one or more digital media applications with one or more media services via a media service bus without having to specify specific ones of media module-dependant parameters.

### TECHNICAL FIELD OF THE INVENTION

The present invention relates generally to digital media solutions, and more particularly relates to integrating media devices and digital media applications in a network environment.

### BACKGROUND OF THE INVENTION

The media industry is transitioning from traditional analog tape based workflows to digital media workflows. Drastic cost reductions in storage, networking, and computing infrastructure in the recent years is making digitization viable for use in digital media applications. This has resulted in significant investments in digital media applications, both in hardware and software. However, the digitization of content is creating disparate systems that have limited interoperability. This poses a significant challenge to businesses and organizations that desire to streamline these investments to achieve higher returns.

One problem with the current media solutions is the presence of heterogeneous and multi vendor environment. The rapid proliferation of digitization in the media industry has resulted in a wide range of applications/products that process digital content. These applications are located across the media organizations—in various departments, in some cases even across organizational boundaries. Each application has evolved independently, which are developed around products from multiple vendors. This has resulted in applications that run on heterogeneous platforms, having specific communication protocols that do not interoperate.

Another problem with the current media solutions is that the existing digital media applications are monolithic. For example, digital media applications within an organization have evolved as monolithic blocks as features are added to these digital media applications over time. Further, components that constitute these digital media applications are not inherently amenable to reuse.

Another problem with the existing digital media solutions is protection of existing investment. For example, the media domain is generally mature and has significant investments in high-end technology and products. Most of the operations in media domain are mission critical and require a higher availability. The migration path to digital workflow requires to be non-disruptive and should protect the investments in legacy hardware and applications.

Another problem is that the existing media solutions require a multitude of content and metadata formats. For example, with the advent of digitization, content today exists in several manifestations such as news stories, clips of news, headlines, pictures, published documents and so on. This places a demand to manage a wide range of content formats like MPEG-2 (Moving Picture Experts Group-2), Windows Media, Real, PDF (portable document format), JPEG (Joint Photographic Experts Group) and so on. Further, metadata must be managed at every stage of the content's workflow. Various media products in the content workflow have proprietary mechanisms of modeling and managing metadata. This places a barrier on the free flow of metadata across various products that are included at each stage of the content workflow.

Yet, another problem with the existing media solutions is that they have non linear dynamic workflows. Generally, digital media workflows are quite dynamic—a digital media workflow may have to rapidly adapt to changing business requirements. This means that the set of products that a digital workflow depends upon can be constantly in flux. For example, a digital media workflow might have been depending upon a transcoding product that transcodes data for consumption by more traditional web based clients. However, a sudden requirement to support mobile phone clients might require the digital workflow to use a different product that supports transcoding to mobile devices.

Further, the current solutions provide vertically integrated solutions that have point-to-point integrated products. Typically, a vendor tries to extend a product that performs one core function (like asset management, editing, and so on) into an entire solution offering. These approaches require point integration with other third party products, which are generally not desirable.

Furthermore, some vendors provide a bus based integration approach for legacy platforms. But, these techniques solve problems associated with a tightly coupled, point-to-point integrated stack. However, these vendors have stopped short and do not address other key requirements like support for granular and non-linear media workflows.

In addition, traditional enterprise application integration (EAI) vendors handle conventional data types, but do not provide extensive support for data types that are specific to digital media. Additionally, there is very limited support provided to capture, manage, and distribute media specific metadata.

Generally, digital media solutions today operate in a complex environment that spans across multiple technology platforms, heterogeneous operating systems and networks. Given the technical diversity a typical media solution is built as a vertical stack that integrates products from multiple vendors. They lack widely accepted industry standards making this integration expensive and inflexible.

### SUMMARY OF THE INVENTION

According to an aspect of the subject matter, there is provided a digital media solutions integration network that links one or more digital media applications with one or more third party media services via associated third party media service modules without having to specify specific ones of media module-dependant parameters.

### BRIEF DESCRIPTION OF THE DRAWINGS

Embodiments of the invention will now be described, by way of example only, with reference to the accompanying drawings in which:

FIG. 1 is a block diagram illustrating a digital media solutions integration network according to an embodiment of the present subject matter.

FIG. 2 is block diagram illustrating major modules of a media service client interface and a media service interface shown in FIG. 1 according to an embodiment of the present subject matter.

FIG. 3 is a flowchart illustrating an example method of linking one or more digital media applications to one or more media services via a media service bus according to an embodiment of the present subject matter.

FIG. 4 is a block diagram of a typical computer system used for implementing embodiments of the present subject matter shown in FIGS. 1-3.

### DETAILED DESCRIPTION OF THE INVENTION

In the following detailed description of the various embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The term “third party media service module” refers to a hardware device or software application and/or an application suite that implements media processing functionality such as content ingestion, transcoding, indexing, transfer, and the like. The term “media service” refers to a component that performs some distinct media processing functionality like content ingestion, transcoding, indexing, transfer, and so on. In addition, the media process can also include activities such as metadata management, automation, and the like.

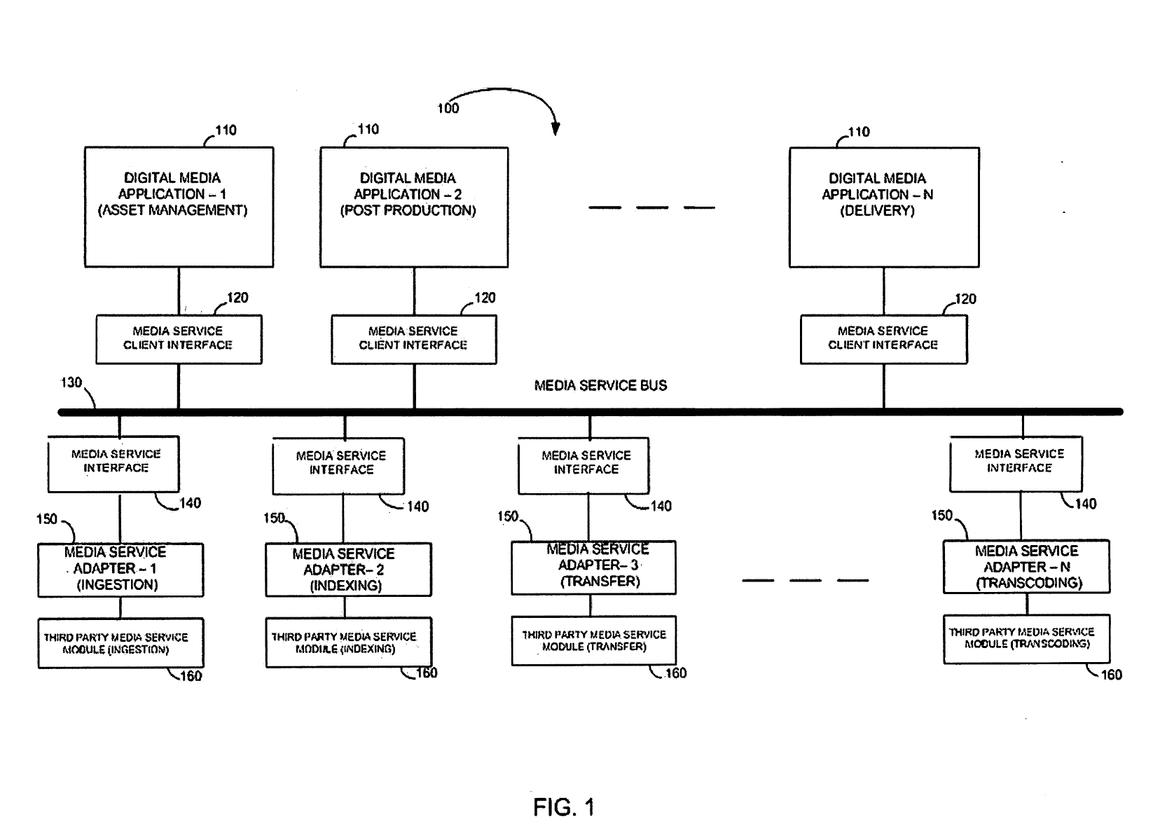

FIG. 1 is a block diagram 100 of a digital media solutions integration network illustrating the operation of linking one or more digital media applications 110 with one or more third party media service modules 160 via a media service bus 130. The block diagram 100 shown in FIG. 1 further illustrates one or more media service client interfaces 120 associated with the one or more digital media applications 110. Further as shown in FIG. 1, the one or more third party media service modules 160 are coupled to one or more associated media service interfaces and adapters 140 and 150, respectively, which are in-turn coupled to the media service bus 130.

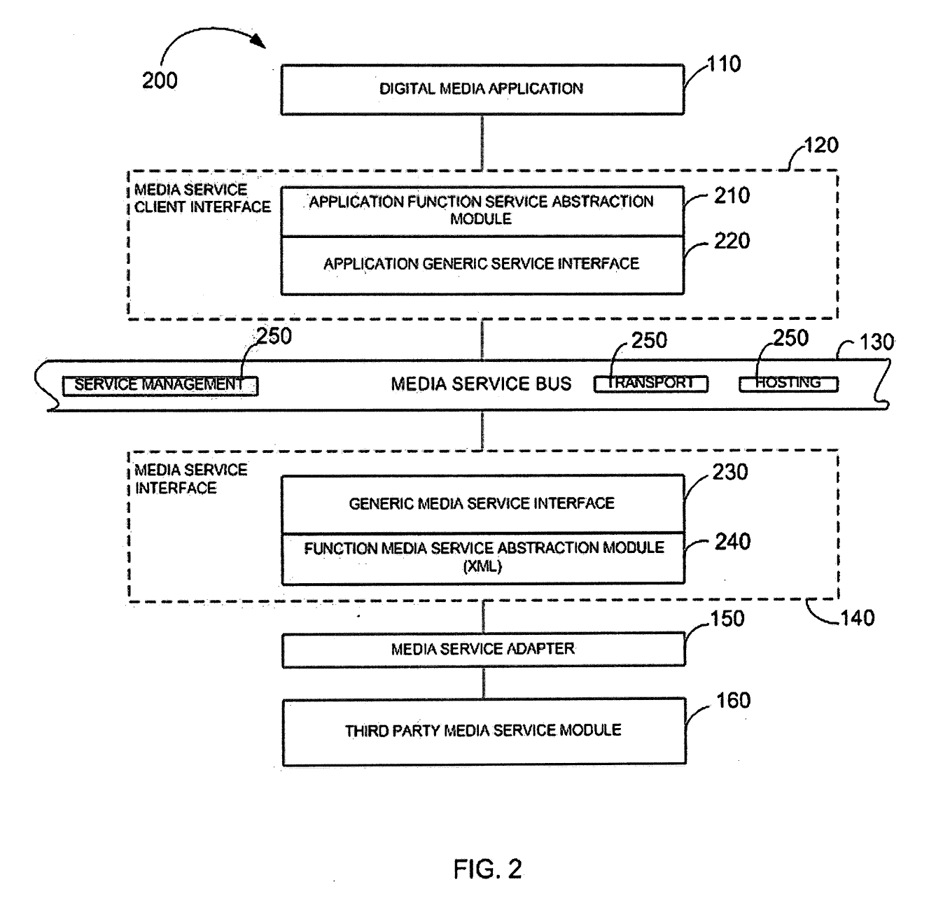

FIG. 2 is a block diagram 200 that illustrates the major function modules of the media service client interface 120 and the media service adapter 150. As shown in FIG. 2, the media service client interface 120 includes an application function service abstraction module 210 and an application generic service interface 220. The application function service abstraction module 210 provides an abstraction of functionality provided by an associated digital media application 110. The application generic service interface 220 conforms to the associated digital media application. Further as shown in FIG. 2, the media service interface 140 includes a generic media service interface 230 and a function media service abstraction module 240. The function media service abstraction module 240 can be an XML (Extended Markup Language) based function media service abstraction module.

In some embodiments, the media service adapter 150 (shown in FIG. 1) implements a media service by linking a third party media service module 160 (shown in FIG. 1) to the generic media service interface 230 using the function media service abstraction module 240. In these embodiments, one or more media service adapters 150 can be implemented by linking the one or more third party media service modules 160 to the generic media service interface 230 using the one or more function media service abstraction modules 240.

Referring now to FIG. 1, in operation, the one or more digital media applications 110 link with one or more third party media service modules 160 via the one or more associated media service client interfaces 120, the media service bus 130, and the one or more associated media service interfaces and media service adapters 140 and 150, respectively. The digital media application is a business application built by composing together one or more third party media services. In these embodiments, digital media applications are built by accessing and composing media services together using the media service client interface 120.

The media service client interface 120 provides digital media application 110 with an implementation agnostic view of media services as used by the applications. For example, the digital media application 110 can use a transcoding media service oblivious of whether hardware cards or software encoders are used to provide the underlying transcoding functionality.

The media service bus 130 provides transport and service management functionality that enables digital media applications 110 to access and manages one or more third party media services. Further, the media service bus 130 provides access to common support services that are routinely required in the digital media applications 110.

The media service bus 130 facilitates communication with the one or more third party media service modules 160 via the digital media applications 110, which can include a range of XML based transport protocols, such as HTTP (hyper text transfer protocol), JMS (Java Message Service), MSMQ (Microsoft Message Queue), and other such messaging oriented middleware. For example, an organization having an asset management application, that might have evolved on a Java platform, can be accessed for asset information using a post production editing system operating on a Microsoft Windows platform via the media service bus 130.

Using the media service client interface 120 and the media service interface 130 enables modeling large applications as a set of services distributed over the network. A media service refers to an abstraction of specific media functionality such as ingest, transcode, rights management, storage, delivery and consumption of the media. All service nodes, across an integration network present a uniform interface to the higher-level business processes. This allows the business process to seamlessly orchestrate services across application boundaries.

In these embodiments, the one or more media service client interfaces 120 are expressed in terms of XML messages exchanged over the media service bus 130. These XML messages capture interactions required to perform media specific processing such as ingest and transcode. Vendor agnostic media services can be implemented on the media service bus 130 by building media service interface and media service adapters 140 and 150, respectively, using third party media products/applications. All media service interfaces 140 include a generic media service interface 230 and a function media service abstraction module to provide a uniform interface to communicate with any one of the one or more media service adapters and third media service modules 150 and 160, respectively. In some embodiments, the media service client interface 120, the media service bus 130, and the media service interface 140 transform the one or more digital media applications 110 into one or more reusable third party media services.

The media service bus 130 provides the transport and service management functionality that enables media applications to discover, access, and manage one or more third party media services. The media service bus 130 provides the following functions.

Transport

The one or more media service adapters 150 and their underlying third party media service modules 160 may be located on a variety of software platforms such as Windows, Unix etc. The media service adapters 150 may require access through a wide range of transports such as HTTP, messaging middleware, FTP etc. The media service bus 130 provides the digital media applications 110 with a transport independent mechanism for accessing media services. This means that a digital media application can be built by composing together services across the network, irrespective of how the media services are deployed and accessed. In addition, multiple digital media applications 110 could be integrated using the media service bus 130. For example, an organization having an asset management application, that might have evolved on a Java platform, can be accessed for asset information using a post production editing system operating on a Microsoft Windows platform via the media service bus 130.

Service Management

The media service bus provides support for managing lifecycle of media services. The service management functionality provides
Configuration, start and stop media services
Health monitoring of media services

Digital media applications 110 built to support dynamic digital workflows generally need to be flexible. The capability to change the media application's behavior dynamically is desirable—and this can be achieved using the above-described integration framework without having to re-implement the application. For instance, a content capture application may use the ingestion media service to capture video to a hi-resolution MPEG-2 file for broadcast to television. Suppose a new requirement needs to support a Web based browser client, then the ingestion service additionally performs extra transcoding functionality to generate a Windows Media based stream format. In such an event, the transcoding functionality is transparently introduced without the need to modify an existing digital media application 110.

The above-described integration framework provides flexibility in the application's workflow using the following features:
The application identifies, describes and discovers the exact kind of media service that it needs to perform its functions dynamically at run-time.
The service is discovered in a location transparent manner. This facilitates in dynamically relocating services to a different host without affecting the application, i.e., the application need not be rebuilt/changed whenever the service it consumes is moved to a different host.
Manages lifecycle and dynamic configuration of services to facilitate executing multiple media services distributed across a network.

The above-described integration framework identifies, discovers, consumes and manages services in a loosely coupled fashion to provide flexible digital media workflows.

Service Addressing

All services are uniquely identified and addressed through a URI referred to as the Service Identifier. The platform uses a global id generator to generate service identifiers. All services at all levels of granularity are identifiable by a service identifier. The service identifier is persistent i.e. it is valid across multiple re-starts of the service.

Service Registration with the Service Repository

The service repository is a centralized registry that stores information about the various media services that are available for the media applications to consume. All services require registering their details with the service repository. The details that are registered for each service include location of the service, the service definition, its capabilities, the supported transport mechanisms, supported quality of service, and the like. The digital media applications 110 and other third party media services may locate appropriate services from the service repository by specifying intelligent queries.

Service Discovery

During the service discovery process, a consumer will request for a third party media service of a particular type and with some desired capabilities. The service repository locates the most suitable third party media service and responds with the information about the appropriate third party media service, based on the consumer's stated requirements, such as a consumer may want to access a third party metadata service that supports MPEG-7 based metadata, and a consumer who wants to access a media service that supports communication over HTTP.

The response payload includes information about the location of the service, its custom capabilities, the supported transport mechanisms and supported quality of service. Custom capabilities can be specified by services by requesting an arbitrary block of XML. The XML format can be conformant to a schema that is specific to the service. Any consumer who is aware of the service specific schema will be able to run more customized searches that would locate various variants of a particular service.

Capabilities Based Service Discovery

Generally, all third party media services advertise their capabilities in a central service repository. The service repository implements the mechanism for services and devices to describe and advertise their capabilities to the digital media applications 110. The capabilities based service discovery refers to the ability of a service consumer to lookup services that match its needs in a dynamic fashion.

Following illustrate some examples of locating third party media services based on the digital media capabilities:
a metadata service that supports MPEG-7 descriptors.
a content transfer service that is aware of media formats. For example, a particular content transfer service that is aware of streamable media formats such as MXF (Material Exchange Format) could be located so that it can perform transfers efficiently to the media format. Again, for instance, a content transfer service that intelligently transfers only a portion of a large MPEG file may be located.
a transcoding service that can transcode to support mobile devices.

The media service bus 130 provides the capability for locating a media service residing on multiple OS platforms and accessible by multiple transports, i.e. to locate a media service that supports a transport that the consumer understands. For example, a consumer who is outside the corporate firewall, (e.g. a news reporter on the field) may want to update metadata related to a scene that the consumer has just captured, into the broadcaster's asset management system. This may require the consumer to locate and use a metadata service that is accessible over a HTTP/Web service transport that works across firewalls.

Another example can be a secure channel is required to be established prior to communication with consumers. The service may declare these security requirements as part of its capabilities. Compatible consumers may locate this particular service and communicate with it after establishing a secure channel.

Service Consumption

The service consumer is returned a service repository response that contains information on the service, such as information on how to access the service. The service consumer may use this information to exchange events with the service through the media service client interface.

The digital media application 110 may consume a service by exchanging events with the third party media service through the service stub obtained via the service discovery process described earlier. The valid set of events that the media application may exchange with a particular service is defined by service definition information configured within the stub.

Service Management

Generally, most of third party media services have requirements of high availability, which requires managing the lifecycle of these services. The service management application allows control and configuration of each third party media service through a distributed service agent mechanism. The service management application controls and manages each service through service agents running on each host where a service is executing. Service agents perform service startup, shutdown and configuration for services, on behalf of the service manager.

The media service bus 130 also provides services that can implement key infrastructure requirements, such as security, logging, scheduling, and collaboration. The common infrastructure services implement such core requirements.

The media service interface 140 shown in FIGS. 1 and 2 makes third party media service agnostic of the underlying third party media service module 160 used to provide the media functionality. Referring now to FIG. 2, the media service interface 140 includes the generic media service interface 230 and the function media service abstraction module 240. The generic media service interface 230 is implemented by building a media service adapter 150 (shown in FIG. 1) that conforms to the generic media service interface 230. The media service adapter 150 provides an implementation of the function service using interfaces provided by the third party media service module 160 (shown in FIG. 1).

The function media service abstraction module 240 provides an abstraction of the functionality offered by a third party media service module 160 (shown in FIG. 1). For example, when a digital media application 100 is built using this service abstraction, the digital media application 110 becomes third party media product agnostic, which can reduce the need for vendor lock-in. The function media service abstraction module 240 is expressed using the function service definition. For a given third party media service, the service definition is a collection of events that the third party media service produce/consume. Generally, such a function service definition is represented using an XML format.

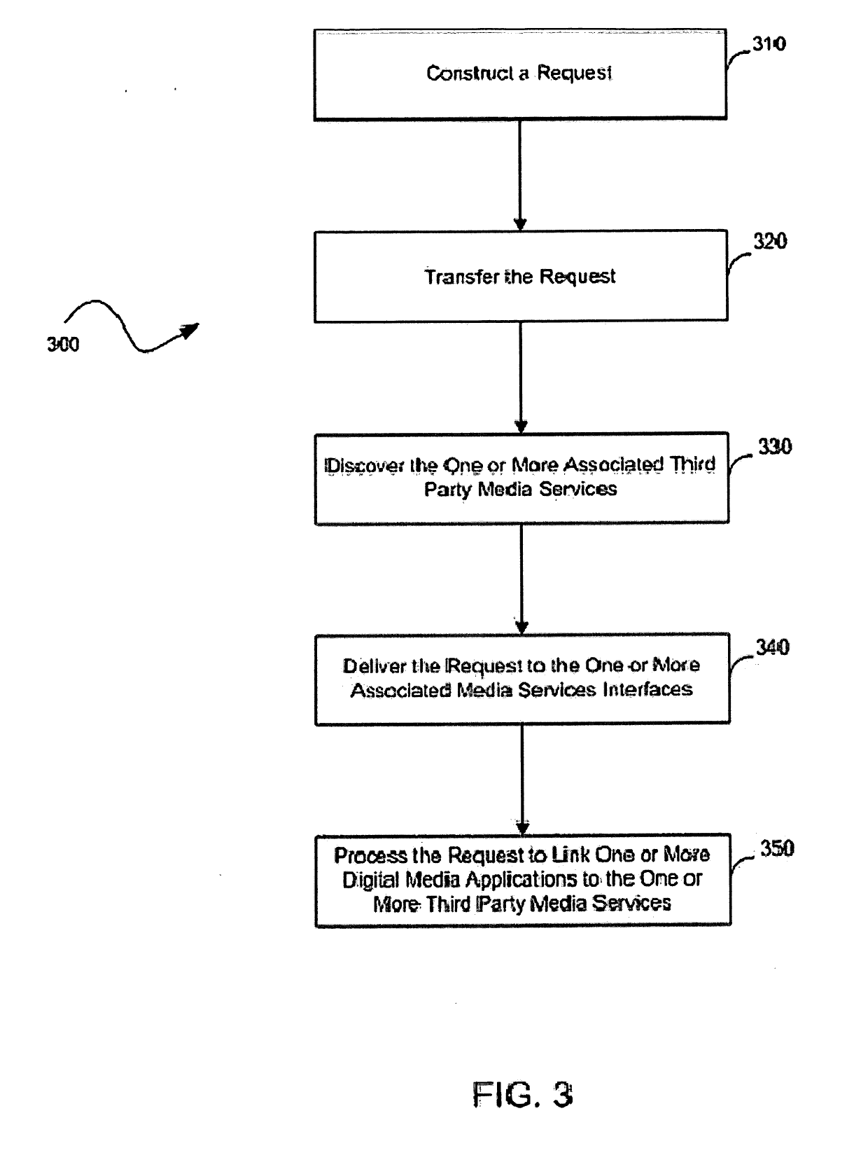

FIG. 3 illustrates an example method 300 for creating an integrated platform for media solutions. At step 310, this example method 300 begins by constructing a request to link one or more third party media services to one or more media applications. A request could be constructed as to enable a content capture application to discover and use multiple third party media services that perform video capture, metadata management and content transfer.

At step 320, the request is transferred to a media service bus via one or more associated media service client interfaces. At step 330, the one or more associated third party media services connected to the media service bus are discovered as a function of the request. At step 340, the request is delivered to one or more associated media service interfaces upon completion of the discovery of the one or more associated third party media services. As described-above the services are discovered based on requirements specified in the request.

At step 350, the request is processed using an associated one or more third party media service interface modules by the associated one or more media service interfaces. The one or more digital media applications are then linked to the one or more third party media services, without specifying specific ones of media module-dependent parameters, upon completion of the processing of the request. For example, consider a content delivery application that could transcode a video file to multiple formats, such as Windows Media and MPEG-2 (Moving Picture Experts Group). Multiple third party media modules exist that can provide media transcoding functionality. Each third party media module may require specific media module-dependent parameters to be specified to perform the transcoding. Exemplary media module-dependent parameters include transcoding using the third party Microsoft Windows Media 9 and different input parameters to initiate transcoding as compared to transcoding using a different third party media module such as Apple Quicktime.

Although the flowchart 300 includes steps 310-350 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

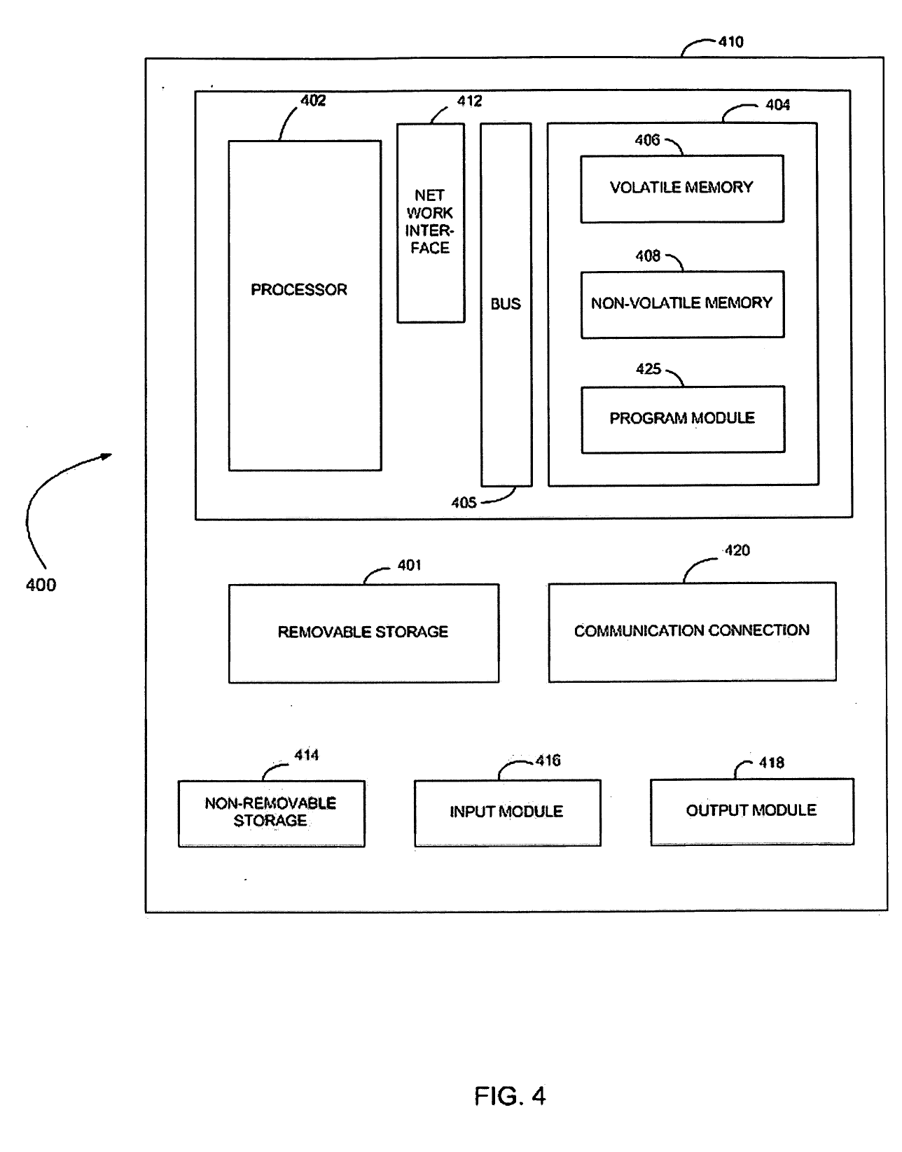

Various embodiments of the present subject matter can be implemented in software, which may be run in the environment shown in FIG. 4 (to be described below) or in any other suitable computing environment. The embodiments of the present subject matter are operable in a number of general-purpose or special-purpose computing environments. Some computing environments include personal computers, general-purpose computers, server computers, hand-held devices (including, but not limited to, telephones and personal digital assistants (PDAs) of all types), laptop devices, multi-processors, microprocessors, set-top boxes, programmable consumer electronics, network computers, minicomputers, mainframe computers, distributed computing environments and the like to execute code stored on a computer-readable medium. The embodiments of the present subject matter may be implemented in part or in whole as machine-executable instructions, such as program modules that are executed by a computer. Generally, program modules include routines, programs, objects, components, data structures, and the like to perform particular tasks or to implement particular abstract data types. In a distributed computing environment, program modules may be located in local or remote storage devices.

FIG. 4 shows an example of a suitable computing system environment for implementing embodiments of the present subject matter. FIG. 4 and the following discussion are intended to provide a brief, general description of a suitable computing environment in which certain embodiments of the inventive concepts contained herein may be implemented.

A general computing device, in the form of a computer 410, may include a processing unit 402, memory 404, removable storage 401, and non-removable storage 414. Computer 410 additionally includes a bus 405 and a network interface (NI) 412.

Computer 410 may include or have access to a computing environment that includes one or more user input modules 416, one or more output modules 418, and one or more communication connections 420 such as a network interface card or a USB connection. The one or more output devices 418 can be a display device of computer, computer monitor, TV screen, plasma display, LCD display, display on a digitizer, display on an electronic tablet, and the like. The computer 410 may operate in a networked environment using the communication connection 420 to connect to one or more remote computers. A remote computer may include a personal computer, server, router, network PC, a peer device or other network node, and/or the like. The communication connection may include a Local Area Network (LAN), a Wide Area Network (WAN), and/or other networks.

The memory 404 may include volatile memory 406 and non-volatile memory 408. A variety of computer-readable media may be stored in and accessed from the memory elements of computer 410, such as volatile memory 406 and non-volatile memory 408, removable storage 401 and non-removable storage 414. Computer memory elements can include any suitable memory device(s) for storing data and machine-readable instructions, such as read only memory (ROM), random access memory (RAM), erasable programmable read only memory (EPROM), electrically erasable programmable read only memory (EEPROM), hard drive, removable media drive for handling compact disks (CDs), digital video disks (DVDs), diskettes, magnetic tape cartridges, memory cards, Memory Sticks™, and the like; chemical storage; biological storage; and other types of data storage.

“Processor” or “processing unit,” as used herein, means any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, explicitly parallel instruction computing (EPIC) microprocessor, a graphics processor, a digital signal processor, or any other type of processor or processing circuit. The term also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, application programs, etc., for performing tasks, or defining abstract data types or low-level hardware contexts.

Machine-readable instructions stored on any of the above-mentioned storage media are executable by the processing unit 402 of the computer 410. For example, a program module 425 may include machine-readable instructions capable of linking one or more applications with one or more media services without having to specify specific device-dependent media service parameters according to the teachings and herein described embodiments of the present subject matter. In one embodiment, the program module 425 may be included on a CD-ROM and loaded from the CD-ROM to a hard drive in non-volitile memory 408. The machine-readable instructions cause the computer 410 to provide an integrated platform according to the various embodiments of the present subject matter. As shown, the program module 425 includes instructions to link the one or more digital media applications with the one or more third party media services according to various embodiments of the present invention.

The operation of the computer system 400 to provide an integrated digital solutions framework is explained in more detail with reference to FIG. 1.

This technique provides a standards based media solutions integrated platform. Also, provides an integrated platform that has scalability and reliability built in. Further, the technique provides a rapid application development approach to media solutions via infrastructure functionality which is pre-built via the dmp common services, out-of-box product adapters, and pre-compiled media workflows.

The technique also provides support for a heterogeneous solutions environment, where multiple vendor devices and applications can provide an integration solution via the media bus architecture. Furthermore, the technique protects the existing investment both in hardware and applications by seamless integration of legacy solutions.

Further the above described process provides an integration network that enables communication by supporting multiple protocols associated with various media services. This enables connectivity among the various isolated applications. Furthermore, this process allows the media applications to collaborate without being impacted by any changes in other applications.

The above description is intended to be illustrative, and not restrictive. Many other embodiments will be apparent to those skilled in the art. The scope of the subject matter should therefore be determined by the appended claims, along with the full scope of equivalents to which such claims are entitled.

It is to be understood that the above-description is intended to be illustrative, and not restrictive. Many other embodiments will be apparent to those of skill in the art upon reviewing the above-description. The scope of the subject matter should, therefore, be determined with reference to the following claims, along with the full scope of equivalents to which such claims are entitled.

As shown herein, the present subject matter can be implemented in a number of different embodiments, including various methods, a circuit, an I/O device, a system, and an article comprising a machine-accessible medium having associated instructions.

Other embodiments will be readily apparent to those of ordinary skill in the art. The elements, algorithms, and sequence of operations can all be varied to suit particular requirements. The operations described-above with respect to the method illustrated in FIG. 1 can be performed in a different order from those shown and described herein.

FIGS. 1-4 are merely representational and are not drawn to scale. Certain proportions thereof may be exaggerated, while others may be minimized. FIGS. 1-4 illustrate various embodiments of the subject matter that can be understood and appropriately carried out by those of ordinary skill in the art.

In the foregoing detailed description of the embodiments of the invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive invention lies in less than all features of a single disclosed embodiment. Thus the following claims are hereby incorporated into the detailed description of the embodiments of the invention, with each claim standing on its own as a separate preferred embodiment.

1. A digital media solutions integration network to link one or more digital media applications with one or more third party media services via associated third party media service modules without having to specify specific ones of media module-dependant parameters.

2. The integration network of claim 1, wherein the digital media solutions framework to link the one or more digital media applications with the one or more third party media services comprises:
one or more associated media service client interfaces coupled to the one or more digital media applications;
a media service bus coupled to the one or more media service client interfaces;
one or more media service interfaces coupled to the media service bus;
one or more associated media service adapters coupled to the one or more media service interfaces; and
one or more associated third party media modules coupled to the associated one or more media service adapters, wherein the one or more associated digital media applications to communicate with the one or more associated third party media service modules via the one or more associated media service client interfaces, the media service bus, and the one or more media service interfaces without having to specify the specific ones of the media module-dependent parameters.

3. The integration network of claim 2, wherein the one or more digital media applications comprises one or more monolithic applications.

4. The integration network of claim 2, wherein the media service client interface, the media service bus, and the media service interface transforms the one or more digital media applications into one or more reusable third party media services.

5. The integration network of claim 2, wherein each of the one or more media service client interfaces comprises:
an application function service abstraction module coupled to the an associated digital media application to provide an abstraction of functionality provided by the associated digital media application; and
an application generic service interface coupled between the application function service abstraction module and the media service bus that conforms to the associated digital media application.

6. The integration network of claim 2, wherein the media service adapter comprises a generic media service interface that is coupled to an XML based function media service abstraction module.

7. The integration network of claim 2, wherein each of the one or more media service interfaces comprises:
a generic media service interface coupled to the media service bus that conforms to an associated media service adapter; and
a function media service abstraction module coupled to the generic service interface that includes media module dependent parameters to provide an abstraction of functionality provided by an associated third party media service module.

8. The integration network of claim 7, wherein the function media service abstraction module comprises:
an XML based function media service abstraction module that is coupled to the generic media service interface and wherein the media service adapter links to an associated third party media service module via the XML based function media service abstraction module.

9. A method, comprising linking one or more digital media applications with one or more third party media services via associated third party media service modules without having to specify specific ones of media module-dependant parameters.

10. The method of claim 9, wherein linking the one or more digital media applications with one or more third party media services comprises:
constructing a request to link the one or more third party media services by the one or more digital media applications;
transferring the request to a media service bus via one or more associated media service client interfaces;
discovering the one or more associated third party media services connected to the media service bus as a function of the request;
delivering the request to one or more associated media service interfaces upon discovering the one or more associated third party media services; and
processing the request for using the associated one or more third party media service interface modules by the associated one or more media service interfaces and linking the one or more digital media applications to the one or more third party media services without having to specify specific ones of media module-dependant parameters.

11. The method of claim 10, further comprising;
establishing a secure channel to link one or more digital media applications with one or more third party media services.

12. An article comprising:
a storage medium having instructions that, when executed by a computing platform, result in execution of a method comprising linking one or more digital media applications with one or more third party media services via associated third party media service modules without having to specify specific ones of media module-dependant parameters.

13. The article of claim 12, wherein linking the one or more digital media applications with one or more third party media services comprises:
constructing a request by the one or more digital media applications to link the one or more third party media services;
transferring the request to a media service bus via one or more associated media service client interfaces;
discovering the one or more associated third party media services connected to the media service bus as a function of the request;
delivering the request to one or more associated media service interfaces upon discovering the one or more associated third party media services; and
processing the request for using an associated one or more third party media service interface modules by the associated one or more media service interfaces and linking the one or more digital media applications to the one or more third party media services without having to specify specific ones of media module-dependant parameters.

14. The article of claim 13, further comprising;
establishing a secure channel to link one or more digital media applications with one or more third party media services.

15. A computer system comprising:
a network interface;
an input module coupled to the network interface that receives the input data via the network interface;
a processing unit; and
a memory coupled to the processor, the memory having stored therein code which when decoded by the processor, the code causes the processor to perform a method comprising linking one or more digital media applications with one or more third party media services via associated third party media service modules without having to specify specific ones of media module-dependant parameters.

16. The system of claim 15, wherein linking the one or more digital media applications with one or more third party media services comprises:
constructing a request to link the one or more third party media services by the one or more digital media applications;
transferring the request to a media service bus via one or more associated media service client interfaces;
discovering the one or more associated third party media services connected to the media service bus as a function of the request;
delivering the request to one or more associated media service interfaces upon discovering the one or more associated third party media services; and
processing the request for using an associated one or more third party media service interface modules by the associated one or more media service interfaces and linking the one or more digital media applications to the one or more third party media services without having to specify specific ones of media module-dependant parameters.

17. The system of claim 16, further comprising;
establishing a secure channel to link one or more digital media applications with one or more third party media services.
